(19) United States
(12) Patent Application Publication
(10) Pub. No.: US 2025/0222728 A1
(43) Pub. Date: Jul. 10, 2025

(54) TIRE VALVE AND VALVE PIN THEREOF

(71) Applicant: THE LEGION ENGINEERING CORPORATION, Changhua City (TW)

(72) Inventor: WAYNE-IAN MOORE, Worcestershire (GB)

(21) Appl. No.: 19/090,864

(22) Filed: Mar. 26, 2025

Related U.S. Application Data
(63) Continuation-in-part of application No. 18/341,347, filed on Jun. 26, 2023.

(51) Int. Cl. B60C 29/00; F16K 1/36; F16K 1/46; F16K 24/00; F16K 27/02

(52) U.S. Cl. CPC B60C 29/005; F16K 1/36; F16K 1/46; F16K 24/00; F16K 27/02

(57) ABSTRACT

The present invention relates to a tire valve and a valve pin thereof. The valve pin includes a body portion, a head portion and a valve seal. The body portion includes a tubular wall, the tubular wall includes a first end and a second end, the tubular wall defines an axial hole and including at least one radial hole in communication with the axial hole, and the axial hole has an opening at the first end of the tubular wall. The head portion is fixedly and integrally connected axially to the second end of the tubular wall, and includes a groove on an outer surface thereof. The valve seal is received within the groove and protrudes radially outward beyond the groove, and is configured for sealingly contacting an inner surface of the tire valve.

### FIELD OF THE INVENTION

The present invention is a CIP of application Ser. No. 18/341,347, filed Jun. 26, 2023, the entire contents of which are hereby incorporated by reference.

### DESCRIPTION OF THE PRIOR ART

A tire valve is installed on the rim and protrudes from the rim for inflation or deflation. Taking the bicycle tire as an example, there are two types of tubed tire and tubeless tire, both of which need the tire valve to carry out air inflation or deflation. The conventional tire valve generally includes a valve body and a valve stem (or valve pin) movably received in the valve body, for controlling communication or discommunication of the air passageway to control the required tire pressure of the tire.

Generally, the air flow rate of inflation and deflation of the tire valve is small, which results in a long inflation or deflation time. In addition, the conventional valve stem and valve assembly have complicated structure and larger size, so it is difficult, time-consuming and labor-intensive in processing, manufacturing and assembling. Furthermore, all kinds of the conventional tire valves cannot be used as adapters and cannot be assembled to different conventional tire valves (for example, the wheel assembly has been provided without the traditional valve core screwed into the valve stem, or the valve core which has malfunctioned is removed from the tire valve).

Moreover, conventional valve cores cannot accommodate the passage of sealing fluids or sealants which are used to prevent flats if the tire integrity has compromised. Therefor such sealing agents need to either be poured into the tire prior to assembly to the rim, or the valve core must be removed to allow sealants to pass into the tire through the valve stem. However, in both cases over time and through normal use the sealants will enter the valve core blocking it and preventing it from functioning. This results in the valve cores needing frequent replacement.

With conventional valve cores the valve pin extends above the valve core body such that it is exposed and vulnerable to damage during use, especially in the case when inflating tire with handheld pumps which induce side loadings to the valve core assembly. In such cases the valve pin can be easily broken or damaged leading to loss of function.

US2005/0197000 discloses that an inner flexible wall extends from the projection of the valve body and gapped radially from an outer wall of the valve body. The inner flexible wall of the valve body has a diameter smaller than the large diameter section of the valve pin, so it is necessary to provide a gap between the inner flexible wall and the outer wall of the valve body so that the inner flexible wall can deformed to allow the large diameter section of the valve pin to pass over the inner flanges whose inner diameters are smaller than the large diameter section of the valve pin when the valve pin is inserted into the passageway of the valve body. Moreover, after the large diameter section of the valve pin passes over the inner flanges of the inner flexible wall, it needs an additional insert disposed between the inner flexible wall and outer wall of the valve body to prevent the valve pin from being not restricted due to the radial deformation of the inner flexible wall. As such, it has a complicated structure and many components, and is difficult to manufactured and assembled.

It should be further noted that the device of US2005/0197000 is not related to tire inflation and requires a male coupler to open the valve pin, which the present invention do not. In addition, there is a spring disposed between and against the large diameter section of the valve pin and the projection of the valve body, so the large diameter section of the valve pin cannot be abutted against and stopped on the projection of the valve body.

The present invention is, therefore, arisen to obviate or at least mitigate the above-mentioned disadvantages.

### SUMMARY OF THE INVENTION

The main object of the present invention is to provide a tire valve and a valve pin thereof which are easy to manufacture, low in cost, fast in assembly and disassembly, small in size, stable in structure and strong in strength.

To achieve the above and other objects, a valve pin for a tire valve is providing, including: a body portion including a tubular wall, the tubular wall including a first end and a second end, the tubular wall defining an axial hole and including at least one radial hole in communication with the axial hole, the axial hole having an opening at the first end of the tubular wall; a head portion fixedly and integrally connected axially to the second end of the tubular wall, and including a groove on an outer surface thereof; and a valve seal received within the groove and protruding radially outward beyond the groove, and configured for sealingly contacting an inner surface of the tire valve.

To achieve the above and other objects, a tire valve including the valve pin is provided, including: a valve body including a passageway and a projection projecting radially inward, the valve pin being disposed in the passageway, the opening of the axial hole and the valve seal being located at opposing sides of the projection, respectively, outer diameters of the tubular wall and the valve seal being larger than an inner diameter of the projection, the valve pin being movable between a sealing position and a communicating position; wherein when the valve pin is located in the sealing position, the valve seal sealingly contacts an inner surface of the valve body to discommunicate the passageway, and when the valve pin is located in the communicating position, the valve seal is free of sealingly contacting the inner surface of the valve body such that the passageway is not discommunicated.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is a cross-sectional view of an exemplary embodiment of the present invention;

FIG. 4 is a cross-sectional view showing the air communication state according to an exemplary embodiment of the present invention;

FIGS. 5 and 6 are stereograms of a valve pin of an exemplary embodiment of the present invention; and

FIG. 7 is an axial side view of FIG. 6.

### DETAILED DESCRIPTION OF THE PREFERRED EMBODIMENTS

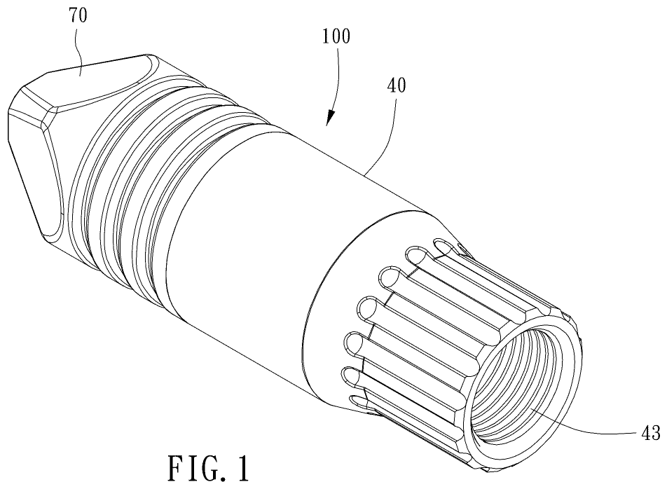

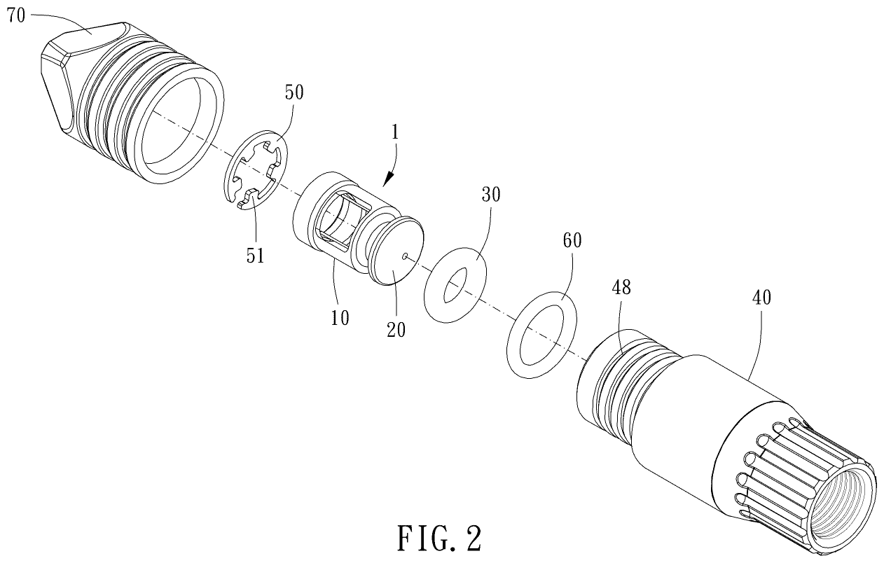

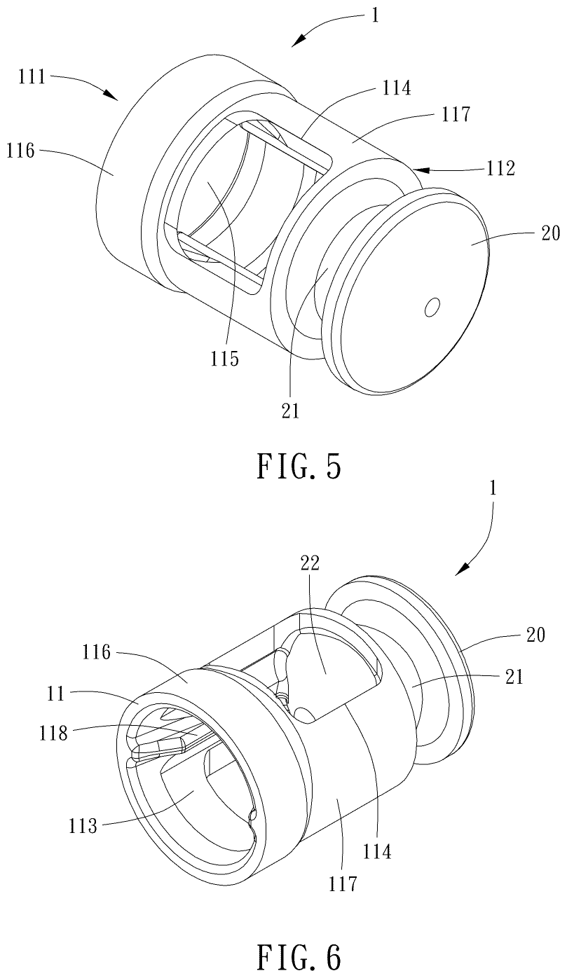

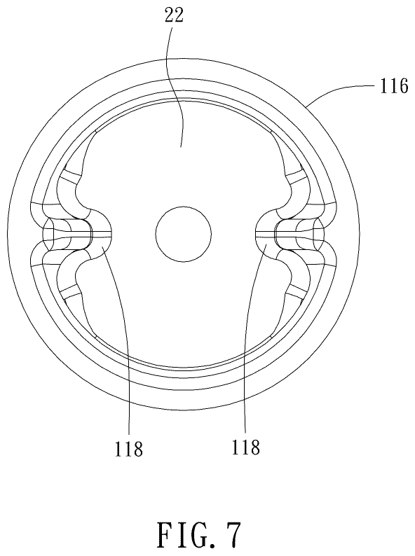

Please refer to FIGS. 1 to 7 for an exemplary embodiment of the present invention. A valve pin 1 for a tire valve of the present invention includes a body portion 10, a head portion 20 and a valve seal 30. The tire valve may be a valve for a bicycle, automobile or other wheel device, and the tire valve may be, for example, a valve for a tubeless tire or a valve for a tubed tire.

The body portion 10 includes a tubular wall 11, the tubular wall 11 includes a first end 111 and a second end 112, the tubular wall 11defines an axial hole 113 and includes at least one radial hole 114 in communication with the axial hole 113, and the axial hole 113 has an opening 115 at the first end 111 of the tubular wall 11. The head portion 20 is fixedly and integrally connected axially to the second end 112 of the tubular wall 11, and the head portion 20 includes a groove 21 on an outer surface thereof. The valve seal 30 is received within the groove 21 and protruding radially outward beyond the groove 21, and is configured for sealingly contacting an inner surface of the tire valve. Whereby, it is easy to manufacture, low in cost, fast in assembly and disassembly, stable in structure and strong in strength. Preferably, the body portion 10 is entirely non-threaded, the tubular wall 11 and the head portion 20 are made of the same material (such as plastic) and formed of one piece; however, the tubular wall 11 and the head portion 20 may be connected by welding, bonding or other methods.

The tubular wall 11 further includes a large diameter section 116 which is annularly closed and a small diameter section 117, and the small diameter section 117 is connected to and between the large diameter section 116 and the head portion 20. The large diameter section 116 is radially protrusive relative to the small diameter section 117, and the at least one radial hole 114 is formed on the small diameter section 117. The body portion 10 further includes at least one reinforcement rib 118 extending on the large diameter section 116 and the small diameter section 117, which reinforces the structural strength of the tubular wall 11. The head portion 20 and the small diameter section 117 have generally the same outer diameter so that the valve pin 1 can be directly inserted, outside-in, into an inner space of the tire valve, thus reducing the size. Specifically, the large diameter section 116 is a closed annular wall, the small diameter section 117 includes two radial holes 114, and the two radial holes 114 are generally rectangle and diametrically opposite to each other. The sum of entire areas of the two radial holes 114 is preferably not smaller than the entire outer area of the small diameter section 117, and thus it has sufficient structural strength and can provide a large gas flow area, which is helpful for large-flow inflation and deflation. The number of the at least one radial hole 114 is not limited to two, and may be three or more.

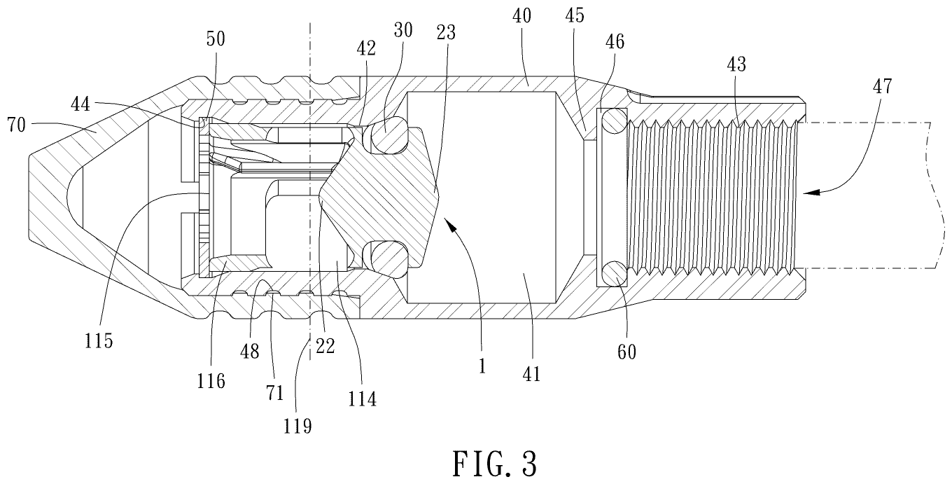

In this embodiment, the second end 112 of the tubular wall 11 is entirely covered by the head portion 20 so that the tubular wall 11 has large structural strength. The head portion 20 includes a convexity 22 convex toward the first end 111 of the tubular wall 11 and extending to be within the axial hole 113, and the head portion 20 further includes a second convexity 23 convex toward a direction away from the second end 112 of the tubular wall 11. In an axial direction of the body portion 10, the at least one radial hole 114 has a dimension at least ⅓ times an axial dimension of the body portion 10 so that the valve pin 1 has a small size and still provides a large gas flow area; the convexity 22 extends not over a central diametric plane 119 of the at least one radial hole 114, which can effectively guide the air flow smoothly. Additionally, in an axial cross-section (FIG. 3), a profile of an end surface of the convexity 22 is continuously and smoothly W-shaped such that it can reduce the flow resistance of gas and effectively guide the air flow to the two radial holes 114.

In this embodiment, the groove 21 is annular, the valve seal 30 is annular, and the valve seal 30 is disposed around the head portion 20 and engaged within the groove 21. The valve seal 30 is preferably made of elastic material such as rubber so that it provides good sealing effect. The head portion 20 is harder than the valve seal 30 so that the head portion 20 can effectively and strongly urge the valve seal 30 to sealingly contact the inner surface of the tire valve.

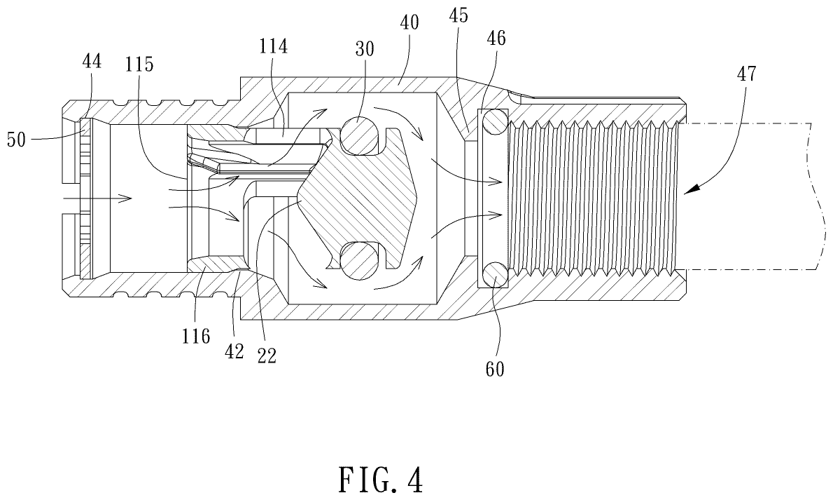

The present invention further provides a tire valve 100. The tire valve 100 includes the valve pin 1 and a valve body 40. The valve body 40 includes a passageway 41 and a projection 42 projecting radially inward, the valve pin 1 is disposed in the passageway 41, and the opening 115 of the axial hole 113 and the valve seal 30 are located at opposing sides of the projection 42, respectively. Outer diameters of the tubular wall 11 and the valve seal 30 are larger than an inner diameter of the projection 42, and the valve pin 1 is movable between a sealing position (FIG. 3) and a communicating position (FIG. 4).

When the valve pin 1 is located in the sealing position, the valve seal 30 sealingly contacts an inner surface of the valve body 40 to discommunicate the passageway 41. When the valve pin 1 is located in the communicating position, the large diameter section of the valve pin 1 is stopped on the projection 42 of the valve body 40 and the valve seal 30 is free of sealingly contacting the inner surface of the valve body 40 such that the passageway 41 is not discommunicated. As the large diameter section 116 is blocked by the projection 42, the two radial holes 114 have the largest cross-sectional area available for air flow to pass therethrough, which can provide high flow rate for quick inflation and deflation.

The valve body 40 may be a one-piece member or a multi-piece assembly. The valve body 40 may be a part of a tire valve assembly, or the valve body 40 may be an adapter for being connected to a valve stem of a valve assembly of a tubeless tire or tubed tire. The valve body 40 includes an inner threaded section 43, and the inner threaded section 43 is configured to be screwed to an outer threaded section of the tire valve assembly.

Preferably, the tire valve further includes a valve pin retainer 50, the inner surface of the valve body 40 includes a recess 44, and the valve pin retainer 50 is engaged in the recess 44 and axially corresponds to and the tubular wall 11 so that the valve pin 1 is retained in the passageway 41. The valve pin retainer 50 may be a C-shaped ring made of metal, and the valve pin retainer 50 includes a plurality of tabs 51 extending radially. As such, the valve pin retainer 50 has great structural strength and can effectively retain the valve pin 1, even under the action of high air pressure, and the valve pin 1 cannot disengage from the valve body 40.

The inner surface of the valve body 40 includes a flange 45 protruding radially and a slot 46 next to the flange 45. A distal end portion of the valve body 40 includes a connection hole 47 next to the slot 46, the flange 45 is located between the valve pin 1 and the slot 46, a stem seal 60 is received in the slot 46, and the stem seal 60 and the valve seal 30 are located by the same side of the projection 42. In this embodiment, the flange 45 and the slot 46 are annular, and the connection hole 47 is a threaded hole configured for connection of a valve body. The stem seal 60 is a ring member received in the slot 46, and the stem seal 60 is preferably made of elastic material such as rubber so that it provides good sealing effect. Specifically, the flange 45 has an inner diameter smaller than an inner diameter of the stem seal 60 so that the stem seal 60 will be not radially protrusive beyond the flange 45 even after being compressed and deformed, and the cross-sectional area for the air flow will not be affected. The slot 46 is recessed radially outward relative to an inner surface of the connection hole 47 so that the stem seal 60 can be reliably retained in the slot 46 without disengagement, and it contributes to the good sealing effect after the valve body 40 and the valve body are screwed to each other.

Preferably, an outer surface of the valve body 40 includes at least one groove 48 extending circumferentially, the tire valve 100 further includes a cap 70, and an inner surface of the cap 70 includes at least one engaging rib 71 extending circumferentially. The at least one engaging rib 71 can be releasably engaged within the at least one groove 48 so that the cap 70 can be releasably mounted (snapped, screwed or the like) to the valve body 40.

The valve pin 1 has a large passage allowing the sealing fluid or sealant to be poured into the tire even after assembly to the rim, so the valve pin 1 needs not to be removed. The large passage also prevents the valve pin 1 from being blocked and out of order due to the sealant. The valve pin 1 does not extend above the valve body 40 such that it is not exposed and not vulnerable to damage and break during use and tire inflation.

Specifically, a diameter of a region of the passageway 41 from a distal end of the valve body 40 to the projection 42 of the valve body 40 is larger than a diameter of the large diameter section 116 of the valve pin 1 and the valve seal 30 is made of elastic material, and the valve seal 30 is radially deformable to allow the valve pin 1 to be directly inserted into the passageway 41 and to allow the valve seal 30 to pass over the projection 42 of the valve body 40 without radially expanding the region of the passageway 41 so that the projection 42 is located between the large diameter section 116 of the valve pin 1 and the valve seal 30 to retain the valve pin 1 in the passageway 41.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tire valve, including:
a valve pin including:
a body portion including a tubular wall, the tubular wall including a first end and a second end, the tubular wall defining an axial hole and including at least one radial hole in communication with the axial hole, the axial hole having an opening at the first end of the tubular wall;
a head portion fixedly and integrally connected axially to the second end of the tubular wall, and including a groove on an outer surface thereof; and
a valve seal received within the groove and protruding radially outward beyond the groove, and configured for sealingly contacting an inner surface of the tire valve;
a valve body including a passageway and a projection projecting radially inward, the valve pin being disposed in the passageway, the opening of the axial hole and the valve seal being located at opposing sides of the projection, respectively, outer diameters of the tubular wall and the valve seal being larger than an inner diameter of the projection, the valve pin being movable between a sealing position and a communicating position;
wherein the tubular wall further includes a large diameter section and a small diameter section, the small diameter section is connected to and between the large diameter section and the head portion, and the large diameter section is radially protrusive relative to the small diameter section;
wherein a diameter of a region of the passageway from a distal end of the valve body to the projection of the valve body is larger than a diameter of the large diameter section of the valve pin and the valve seal is made of elastic material, and the valve seal is radially deformable to allows the valve pin to be directly inserted into the passageway and to allow the valve seal to pass over the projection of the valve body without radially expanding the region of the passageway so that the projection is located between the large diameter section of the valve pin and the valve seal to retain the valve pin in the passageway;
wherein when the valve pin is located in the sealing position, the valve seal sealingly contacts an inner surface of the valve body to discommunicate the passageway, and when the valve pin is located in the communicating position, the large diameter section of the valve pin is stopped on the projection of the valve body and the valve seal is free of sealingly contacting the inner surface of the valve body such that the passageway is not discommunicated.

2. The tire valve of claim 1, further including a valve pin retainer, wherein the inner surface of the valve body includes a recess, and the valve pin retainer is engaged in the recess and axially corresponds to the tubular wall so that the valve pin is retained in the passageway.

3. The tire valve of claim 1, wherein the inner surface of the valve body includes a flange protruding radially and a slot next to the flange, a distal end portion of the valve body includes a connection hole next to the slot, the flange is located between the valve pin and the slot, a stem seal is received in the slot, the stem seal and the valve seal are located by the same side of the projection, and the slot is recessed radially outward relative to an inner surface of the connection hole.

4. The tire valve of claim 1, wherein the body portion further includes at least one reinforcement rib extending on the large diameter section and the small diameter section.

5. The tire valve of claim 1, wherein the head portion includes a convexity convex toward the first end of the tubular wall and extending to be within the axial hole.

6. The tire valve of claim 5, wherein in an axial direction of the body portion, the convexity extends not over a central diametric plane of the at least one radial hole.

7. The tire valve of claim 5, wherein in an axial cross-section, a profile of an end surface of the convexity is continuously and smoothly W-shaped.

8. The tire valve of claim 1, wherein the tubular wall and the head portion are made of the same material and formed of one piece.

9. The tire valve of claim 1, wherein the body portion is entirely non-threaded.

10. The tire valve of claim 1, wherein in an axial direction of the body portion, the at least one radial hole has a dimension at least ⅓ times an axial dimension of the body portion.
